(19) United States
(12) Patent Application Publication
(10) Pub. No.: US 2015/0220432 A1
(43) Pub. Date: Aug. 6, 2015

(54) METHOD AND APPARATUS FOR MANAGING AT LEAST ONE NON-VOLATILE MEMORY

(71) Applicant: Mediatek Inc., Hsin-Chu (TW)

(72) Inventor: Ping-Yi Hsu, Kaohsiung City (TW)

(21) Appl. No.: 14/685,591

(22) Filed: Apr. 13, 2015

Related U.S. Application Data
(63) Continuation-in-part of application No. 13/369,313, filed on Feb. 9, 2012, now abandoned.
(60) Provisional application No. 61/540,363, filed on Sep. 28, 2011.

(51) Int. Cl. G06F 12/02

(52) U.S. Cl. CPC G06F 12/0246; G06F 2212/7201

(57) ABSTRACT

A method and apparatus for managing at least one NV memory are provided. Each NV memory comprises a plurality of physical blocks. The method includes: managing the physical blocks of each of non-volatile (NV) memory according to a block address mapping algorithm in a control module of a memory management apparatus; managing the plurality of pseudo blocks according to a block address translation rule in a management module of the memory management apparatus; and when a command being detected, determining a specific pseudo block address corresponding to a specific block logical address in the command according to the block address translation rule, then determining at least one group of specific physical block addresses corresponding to the specific pseudo block address according to the block address mapping algorithm, and then processing a specific physical block group corresponding to the group of specific physical block addresses according to the command.

### CROSS REFERENCE TO RELATED APPLICATIONS

This application is a Continuation-In-Part of U.S. non-provisional application Ser. No. 13/369,313, which was filed on Feb. 9, 2012 and is entitled “METHOD AND APPARATUS FOR PERFORMING MEMORY MANAGEMENT”, and is incorporated all herein by reference. In addition, the U.S. non-provisional application Ser. No. 13/369,313 claims the benefit of U.S. provisional application No. 61/540,363, which was filed on Sep. 28, 2011.

### BACKGROUND

The present invention relates to access control of a non-volatile (NV) memory, and more particularly, to a method for performing memory management, and to an associated apparatus.

Typically, options of the minimum size of a physical block of a specific type of Flash memories are limited. For example, specifications provided by some Flash memory manufacturers of NOR Flash memories may indicate that the minimum size of a physical block can be either 4 kilobytes (KBs) or 64 KBs. Flash memory is NOT freely re-writeable, written physical blocks cannot be overwrite again until the blocks are being erased, so data update must write to another free block. Through address translation, The Flash Translation Layer (FTL) makes the managed Flash Memory volume appears to be a freely re-writeable logical block device. So that logical block address based file systems like FAT and ext4 can be operated over FTL.

FIG. 1 and FIG. 2 are diagrams of NOR flash memory management system structures, respectively. As shown in FIG. 1 and FIG. 2, the file system allocates files over logical blocks, and the FTL translates logical block addresses to physical block addresses, wherein the FTL reserved a block for data update/garbage collection.

FTL can handle limited number of blocks, managing the NOR Flash memory in units of 4 KBs may cause the overall storage volume of a memory device/module implemented with the NOR Flash memory to be too small. For example, according to FIG. 1, if the FTL can only handle 127 blocks, the volume size is limited to 127*4 KB=508 KB, and the actual applicable space is 508 KB−4 KB=504 KB. In this case, the volume had reached its maximum capacity, since the FTL can handle 127 blocks at most.

FTL has to reserve at least one block for garbage collection for each volume. Managing the NOR Flash memory in units of 64 KBs causes FTL's reserving more space on the NOR Flash memory, and reduces applicable space in the volume. For example, according to FIG. 2, if the volume managed by FTL has size of 12 blocks*64 KB=768 KB, the actual applicable space is 768 KB−64 KB=704 KB. In this case, 8.3% (64 KB) of volume space is reserved by the FTL.

In other words, managing the NOR Flash memory in units of 4 KBs may cause the overall storage volume of a memory device/module implemented with the NOR Flash memory to be too small, while managing the NOR Flash memory in units of 64 KBs may cause a reserved space of the NOR Flash memory to be oversized.

However, options of block size (alias erase unit) of a specific type of Flash memories are limited and fixed. For example, specifications provided by some Flash memory manufacturers of NOR Flash memories may indicate that the size of the erase unit cannot be anything but 4 kilobytes (KBs) or 64 KBs. And as described above, the limitation of 4 KBs and 64 KBs causes problems.

Furthermore, the file system usually have to spend lots of time to do data integrity check on all files in the managed volume, since some NOR Flash memory have disturbance issues.

Thus, a novel and flexible method is required for enhancing access control to non-volatile (NV) Flash memory.

### SUMMARY

It is therefore an objective of the claimed invention to provide a method for managing at least one NV memory, and to provide an associated apparatus, in order to solve the above-mentioned problems.

In accordance with an aspect of the present invention, a method is provided for managing at least one NV memory. Each NV memory comprises a plurality of physical blocks. The method comprises: managing the physical blocks of each of NV memory according to a block address mapping algorithm in a control module of a memory management apparatus; managing the plurality of pseudo blocks according to a block address translation rule in a management module of the memory management apparatus; and when a command being detected, determining a specific pseudo block address corresponding to a specific logical block address in the command according to the block address translation rule, then determining at least one group of specific physical block addresses corresponding to the specific pseudo block address according to the block address mapping algorithm, and then processing a specific physical block group corresponding to the group of specific physical block addresses according to the command. The plurality of physical blocks are grouped into a plurality of physical block groups, and the block address mapping algorithm is used to mapping each of the physical block groups to a pseudo block of a plurality of pseudo blocks. The block address translation rule is used to mapping each of the pseudo blocks to a logical block of a plurality of logical blocks. In particular, the command is selected from an erase command, a read command, and a write command.

In accordance with another aspect of the present invention, an apparatus is provided for managing at least one non-volatile (NV) memory. Each NV memory comprises a plurality of physical blocks. The apparatus comprises a processing circuit. The processing circuit comprises a management module and a control module. The management module is arranged to manage a plurality of pseudo blocks according to a block address translation rule. The block address translation rule is used to mapping each of the pseudo blocks to a logical block of a plurality of logical blocks. The control module is arranged to manage the physical blocks according to a block address mapping algorithm. The plurality of physical blocks are grouped into a plurality of physical block groups, and the block address mapping algorithm is used to mapping each of the physical block groups to a pseudo block of the plurality of pseudo blocks. The control module is also arranged to control access to the NV memory. When a command is detected, the management module determines a specific pseudo block address corresponding to a specific logical block address in the command according to the block address translation rule, then the control module determines at least one group of specific physical block addresses corresponding to the specific pseudo block address according to the block address mapping algorithm. Then the processing circuit processes a specific physical block group corresponding to the group of specific physical block addresses according to the command. In particular, the command is selected from an erase command, a read command, and a write command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an NOR flash memory management system structure of related art.

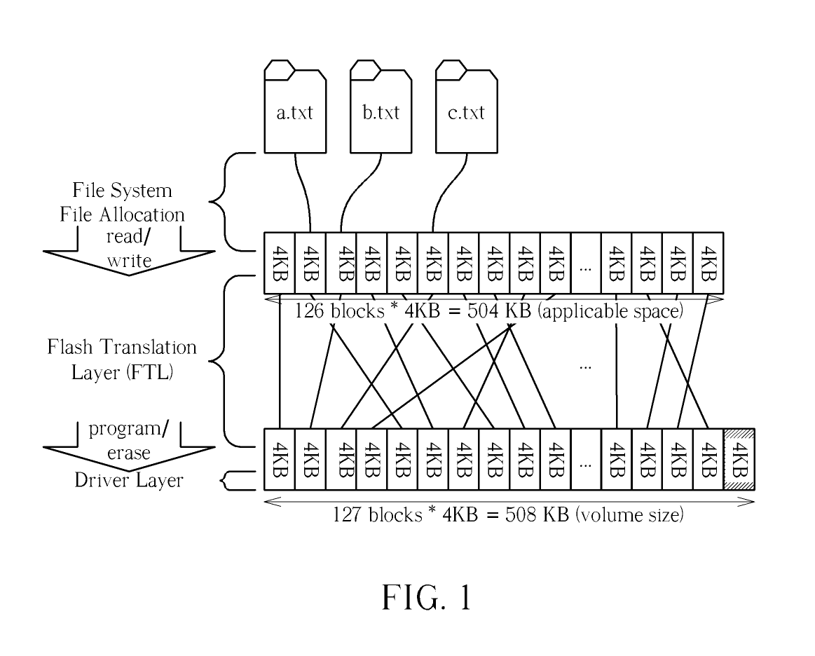

FIG. 2 is a diagram of another NOR flash memory management system structure of related art.

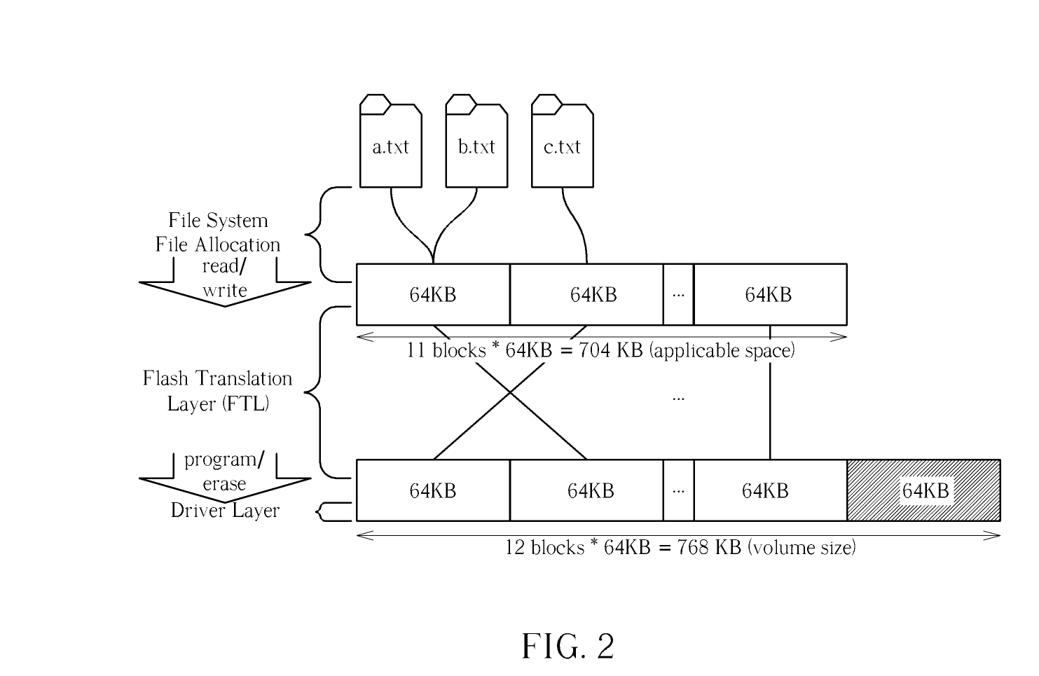

FIG. 3 is a diagram of an apparatus for managing NV memory according to one embodiment of the present invention.

FIG. 4 is a flowchart of a method for managing NV memory according to another embodiment of the present invention.

FIG. 5 is a block address mapping scheme involved with the method shown in FIG. 4 according to another embodiment of the present invention.

FIG. 6 is a block address mapping scheme involved with the method shown in FIG. 4 according to another embodiment of the present invention 5.

FIG. 7 is a block address mapping scheme involved with the method shown in FIG. 4 according to another embodiment of the present invention.

FIG. 8 is a diagram of an NV memory management system structure according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

In the physical design of non-volatile (NV) memories such as NOR Flash memories, blocks that sharing common bit-lines and/or word-lines are called “Block Group” when a block erase operation is interrupted by power-loss, other blocks in the same block group may have one or more bit-flipping. Power-loss is very common on mobile communication devices, and user-data corruption must be avoided. The easiest way to avoid integrity check is letting FTL manage Flash in Block Groups instead of Blocks. I.e. erase operations are performed group-wise. However, the FTL usually only can recognize one block layout, and doesn't aware the physical block grouping of underlying Flash memory.

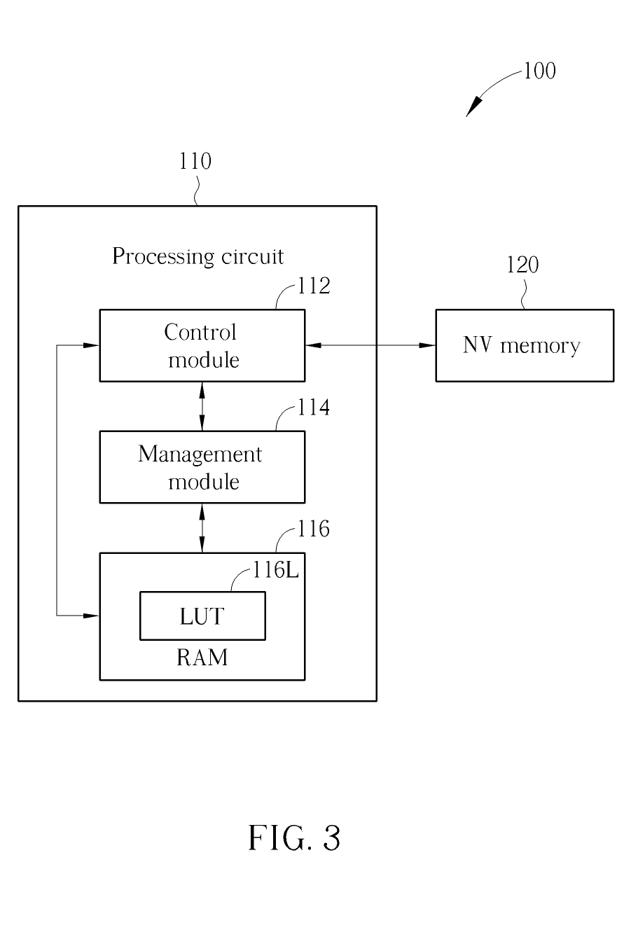

Please refer to FIG. 3, which is a diagram of an apparatus 100 for managing NV memory according to one embodiment of the present invention. According to different embodiments, such as the embodiment shown in FIG. 3 and some other embodiments, the apparatus 100 may comprise at least one portion (e.g. a portion or all) of an electronic device. For example, the apparatus 100 may comprise a portion of the electronic device mentioned above, and more particularly, can be a control circuit such as an integrated circuit (IC) within the electronic device. In another embodiment, the apparatus 100 can be the whole of the electronic device mentioned above. In another embodiment, the apparatus 100 can be an audio/video system comprising the electronic device mentioned above. Embodiments of the electronic device may include, but not limited to, a mobile phone (e.g. a multifunctional mobile phone), a personal digital assistant (PDA), a portable electronic device such as the so-called tablet (based on a generalized definition), and a personal computer such as a tablet personal computer (which can also be referred to as the tablet, for simplicity), a laptop computer, or desktop computer.

As shown in FIG. 3, the apparatus 100 comprises a processing circuit 110 and at least one non-volatile (NV) memory 120, where the processing circuit 110 comprises a control module 112, a management module 114, and a memory such as a random access memory (RAM) 116. The processing circuit 110 is arranged to control operations of the electronic device, and the NV memory 120 is arranged to store information that can be accessed by the processing circuit 110. The NV memory comprises a plurality of physical blocks. More particularly, the management module 114 is arranged to manage a plurality of pseudo blocks according to a block address translation rule, and the block address translation rule is to map each of the pseudo blocks to a logical block of a plurality of logical blocks. In addition, the control module 112 is arranged to manage the physical blocks according to a block address mapping algorithm. The plurality of physical blocks are grouped into a plurality of physical block groups, and the block address mapping algorithm is to map each of the physical block groups to a pseudo block of the plurality of pseudo blocks. The control module 112 is also arranged to control access to the NV memory 120 according to the block address mapping algorithm, and more particularly, according to some block address mapping information associated to the block address mapping algorithm mentioned above. When a command is detected, the management module 114 determines a specific pseudo block address corresponding to a specific logical block address in the command according to the block address translation rule. The control module 112 determines at least one group of specific physical block addresses corresponding to the specific pseudo block address according to the block address mapping algorithm, and then processes a specific physical block group corresponding to the group of specific physical block addresses according to the command. In practice, the aforementioned at least one NV memory 120 may comprise at least one NOR Flash memory. In one embodiment, more particularly, the NV memory 120 can be the NOR Flash memory.

According to an embodiment of the invention, the control module 112 determines the specific group of physical block addresses according to at least one look-up table (LUT) 116L temporarily stored in the RAM 116, as shown in FIG. 3. While in other embodiments, the specific group of physical block addresses are determined by an algorithm or called formula. This is for illustrative purposes only, and is not meant to be a limitation of the present invention.

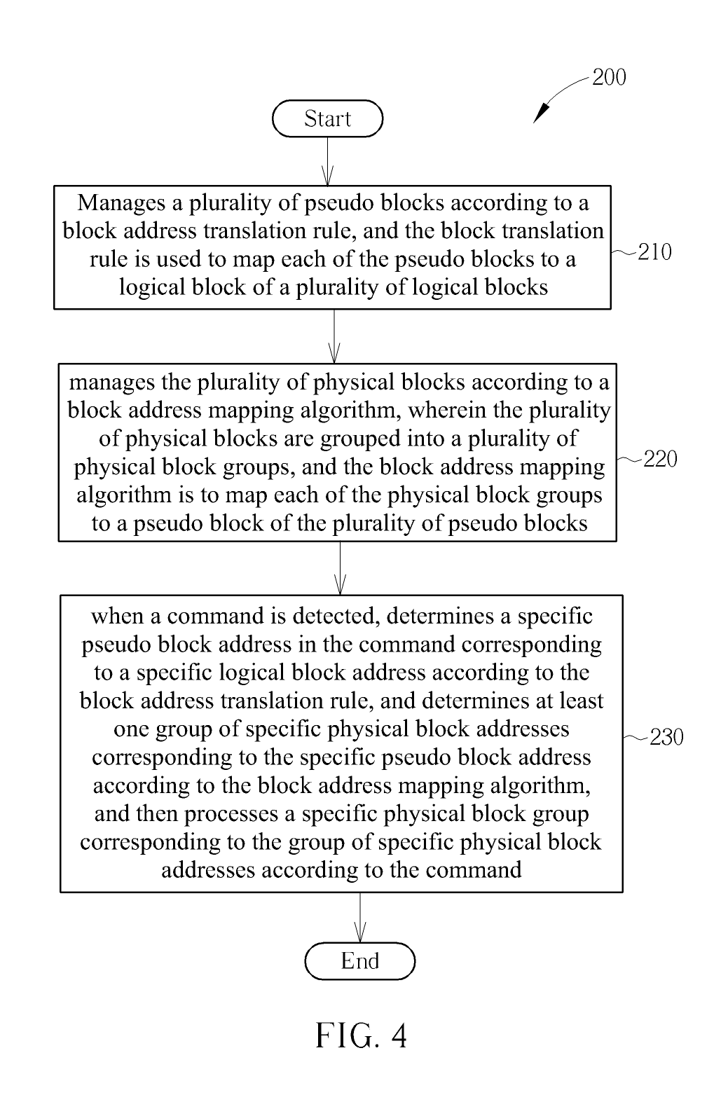

FIG. 4 is a flowchart of a method 200 for managing at least one NV memory according to another embodiment of the present invention. Each NV memory comprises a plurality of physical blocks. The method shown in FIG. 4 can be applied to the apparatus 100 shown in FIG. 3. The method is described as follows.

In Step 210, the processing circuit 110 (more particularly, the management module 114) manages a plurality of pseudo blocks according to a block address translation rule, and the block translation rule is used to map each of the pseudo blocks to a logical block of a plurality of logical blocks.

In Step 220, the processing circuit 110 (more particularly, the control module 112) manages the plurality of physical blocks according to a block address mapping algorithm, wherein the plurality of physical blocks are grouped into a plurality of physical block groups, and the block address mapping algorithm is to map each of the physical block groups to a pseudo block of the plurality of pseudo blocks, as mentioned above. For example, under control of the control module 112, the aforementioned block address translation information associated to the block address mapping algorithm can be implemented as at least one look-up table (LUT) 116L temporarily stored in the RAM 116, and a backup version of the block address mapping information can be stored in a storage unit/module (e.g. a NV memory such as the NV memory 120, or a storage device that differs from the NV memory 120) within the apparatus 100.

In Step 230, when a command is detected, for example, a command to erase a specific logical block represented by a specific logical block address, the processing circuit 110 (more particularly, the control module 112) determines a specific pseudo block address in the command corresponding to a specific logical block address according to the block address translation rule, and determines at least one group of specific physical block addresses corresponding to the specific pseudo block address according to the block address mapping algorithm, and then processes a specific physical block group corresponding to the group of specific physical block addresses according to the command. In the embodiment that the command is to erase the specific logical block, according to the command, the processing circuit 110 (more particularly, the control module 112) further erases a specific physical block group represented by the group of specific physical block addresses within the plurality of physical blocks.

In another embodiment, the command is a read command to read a specific logical block represented by a specific logical block address. In this case, the processing circuit 110 (more particularly, the control module 112) further reads a specific physical block group corresponding to the group of specific physical block addresses. In yet another embodiment, the command is a write command to write to a specific logical block represented by a specific logical block address. In this case, the processing circuit 110 (more particularly, the control module 112) further writes to a specific physical block group corresponding to the group of specific physical block addresses. This is for illustrative purposes only, and is not meant to be a limitation of the present invention. The command is not limited to erase command, read command and write command. Any command that can apply the determining steps falls within the scope of the present invention.

The flowcharts shown above are intended to illustrate an embodiment of managing at least one NV memory according to the present invention. A person skilled in the art may modify each step, re-arranges the steps, split a step, or combine steps to practice the present invention without departing from the spirit of the present invention.

Typically, the size of the specific logical block is equals to that of the specific pseudo block, and the size of the specific pseudo block is a multiple of that of each of the physical blocks. More particularly, the ratio of the size of each pseudo block to that of corresponding physical blocks in a physical blocks group is equal to a predetermined positive integer. For example, in a situation where the predetermined positive integer is equal to two, the size of each pseudo block is twice the size of any physical block within the corresponding physical block group. In another embodiment, in a situation where the predetermined positive integer is equal to three, the size of each pseudo block is triple the size of any physical block within the corresponding of physical block group.

According to this embodiment, the control module 112 can store/update at least one LUT such as the aforementioned at least one LUT 116L according to the block address mapping algorithm to manage the plurality of physical blocks, and the control module 112 can determine the group of block physical addresses mentioned in Step 220 according to the LUT 116L. Typically, within the LUT 116L, the number of block physical addresses corresponding to a first pseudo block address is equal to that of block physical addresses corresponding to a second pseudo block address. For example, the number of block physical addresses corresponding to the pseudo block address S_Add_{—}1 is equal to the number of block physical addresses corresponding to the pseudo block address S_Add_{—}2, where the pseudo block addresses L_Add_{—}1 and L_Add_{—}2 are different from each other. More particularly, within the LUT 116L, the number of block physical addresses corresponding to each pseudo block address is equal to a predetermined number. For example, in a situation where the predetermined number is equal to two, the number of block physical addresses corresponding to the pseudo block address S_Add_{—}1 is equal to two, and the number of block physical addresses corresponding to the pseudo block address S_Add_{—}2 is equal to two. In another embodiment, in a situation where the predetermined number is equal to three, the number of block physical addresses corresponding to the pseudo block address S_Add_{—}1 is equal to three, and the number of block physical addresses corresponding to the pseudo block address S_Add_{—}2 is equal to three.

In addition, the electronic device mentioned above can be a portable electronic device, and the NV memory 120 can be utilized for storing program codes to be executed by the portable electronic device (more particularly, the processing circuit 110). For example, the NV memory 120 can be embedded in the portable electronic device, and can be positioned outside the processing circuit 110. This is for illustrative purposes only, and is not meant to be a limitation of the present invention. According to another embodiment, the NV memory 120 can be embedded in the processing circuit 110. According to another embodiment, the NV memory 120 can be positioned in an external device outside the portable electronic device.

No matter whether the NV memory 120 is positioned within the portable electronic device or outside the portable electronic device, and no matter whether the NV memory 120 is positioned within the processing circuit 110 or outside the processing circuit 110, the operations of the method 200 shown in FIG. 4 and associated operations will not be hindered. For example, when it is detected that reading a portion of a physical block of the NV memory 120 is required, the control module 112 can read the portion of the physical block byte by byte.

In some embodiments, such as some variations of the embodiment shown in FIG. 4, at least one portion (e.g. a portion or all) of the operations of Step 210 to Step 230 can be repeated. In some embodiments, such as some variations of the embodiment shown in FIG. 4, at least one portion (e.g. a portion or all) of the operations of Step 210 to Step 230 can be performed at the same time.

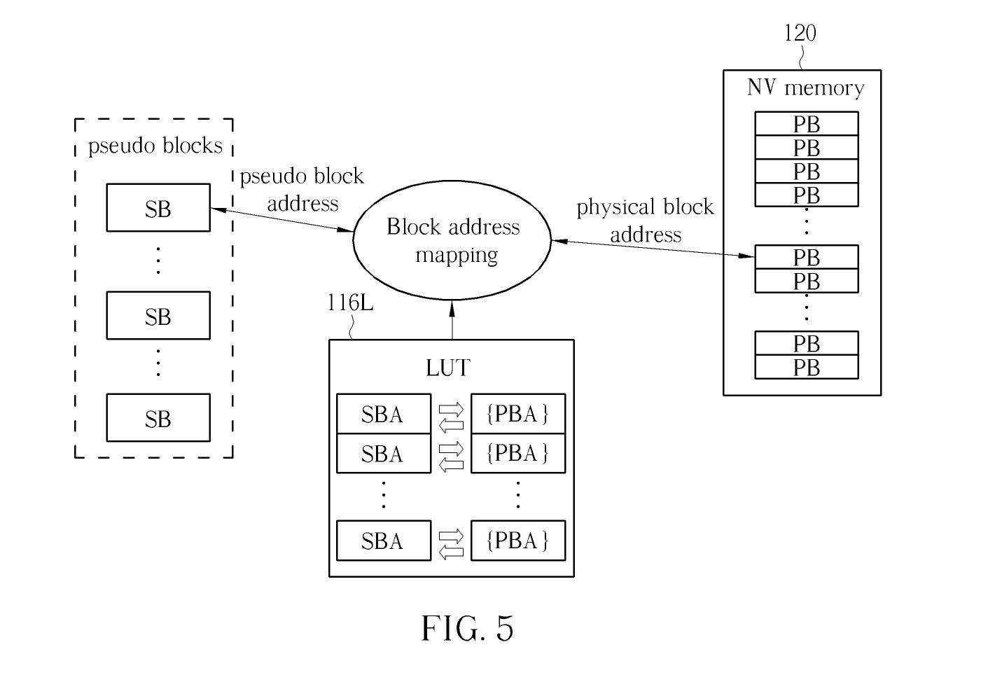

FIG. 5 is a block address mapping scheme involved with the method 200 shown in FIG. 4 according to another embodiment of the present invention.

In the embodiment shown in FIG. 5, the LUT 116L indicates bi-directional mapping relationships between the pseudo block addresses (such as a plurality of pseudo block addresses, each of which is labeled “SBA” in FIG. 5) and the corresponding groups of physical block addresses (such as a plurality of groups of physical block addresses, each group of which is labeled “{PBA}” in FIG. 5), where the contents of the LUT 116L may be updated when needed. For example, a physical block (which is labeled “PB” in FIG. 5) in this embodiment, may correspond to a pseudo block (which is labeled “SB” in FIG. 5). Based on the LUT 116L disclosed above, the block address mapping operation performed by the processing circuit 110 may map the pseudo block address representing the pseudo block under consideration to the physical block address representing the physical block corresponding to this pseudo block, or map the physical block address representing the physical block to the pseudo block address representing the pseudo block under consideration.

As the block address mapping scheme disclosed in FIG. 5 can be implemented as a bottom layer of the access control of the NV memory 120, each pseudo block is substantially implemented by utilizing multiple physical blocks (more particularly, two physical blocks in this embodiment). Similar descriptions are not repeated in detail for this embodiment.

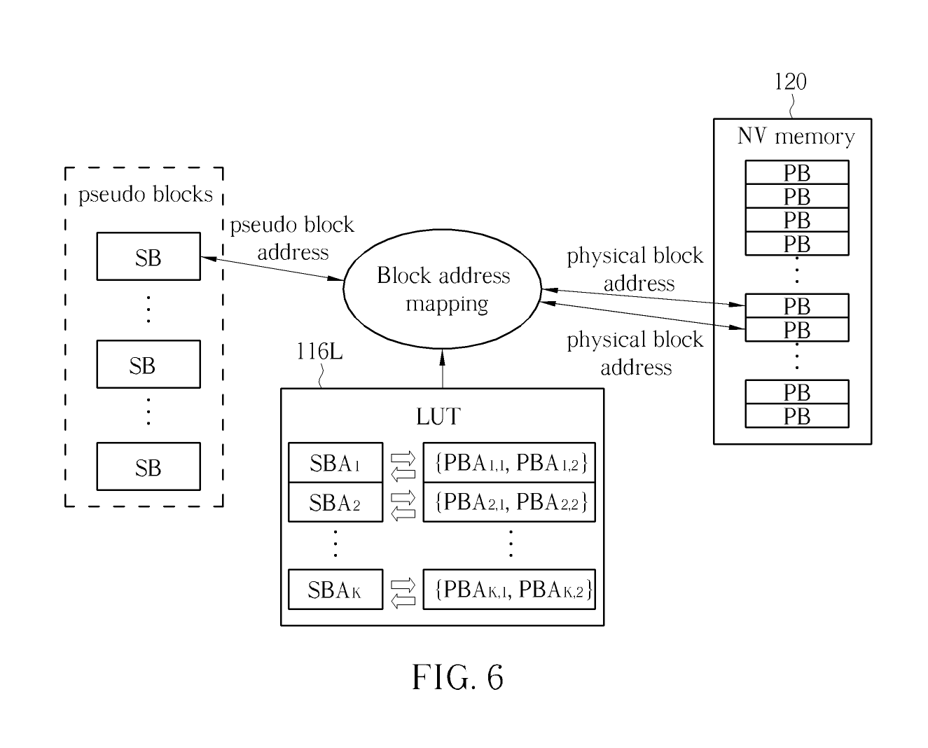

FIG. 6 is a block address mapping scheme involved with the method 200 shown in FIG. 4 according to another embodiment of the present invention. In the embodiment, some pseudo blocks are illustrated to have a larger size than a physical block of some exemplary groups of physical blocks corresponding to these pseudo blocks, respectively. For example, the size of any of the pseudo blocks shown in FIG. 6 can be twice the size of each of the physical blocks shown in FIG. 6. This is for illustrative purposes only, and is not meant to be a limitation of the present invention. According to another embodiment, the size of each of the pseudo blocks under consideration can be another multiple of the size of each of the physical blocks under consideration. According to another embodiment, the size of any of the pseudo blocks of a first pseudo block group can be a first multiple of the size of any of the physical blocks associated to the first pseudo block group, and the size of any of the pseudo blocks of a second pseudo block group can be a second multiple of the size of any of the physical blocks associated to the second pseudo block group. According to another embodiment, the size of any of the pseudo blocks under consideration can be greater than the size of any of the physical blocks under consideration, where it is unnecessary that the size of any of the pseudo blocks under consideration is exactly a multiple of the size of any of the physical blocks under consideration in these variations, i.e., the ratio of the size of a pseudo block to that of a physical block can be a positive real number in these variations. In this embodiment, some pseudo block addresses SBA₁, SBA₂, . . . , and SBA_{K}, with the notation K representing a positive integer, are taken as embodiments of the pseudo block addresses respectively labeled “SBA” in FIG. 5, and some exemplary groups of physical block addresses {PBA_{1,1}, PBA_{1,2}}, {PBA_{2,1}, PBA_{2,2}}, . . . , and {PBA_{K,1}, PBA_{K,2}} are taken as embodiments of the corresponding groups of physical block addresses respectively labeled “{PBA}” in FIG. 5.

Based on the LUT 116L disclosed above, the block address mapping operation performed by the processing circuit 110 may map the pseudo block address representing the pseudo block under consideration (e.g. a pseudo block address SBAₖ, with the notation k representing an integer falling within the range of the interval [1, K]) to the two physical block addresses respectively representing the two physical blocks corresponding to this pseudo block (e.g. a group of physical block addresses {PBA_{k,1}, PBA_{k,2}}), or map the two physical block addresses respectively representing the two physical blocks (e.g. the group of physical block addresses {PBA_{k,1}, PBA_{k,2}}) to the pseudo block address representing the pseudo block under consideration (e.g. the pseudo block address SBAₖ). Similar descriptions are not repeated in detail for this embodiment.

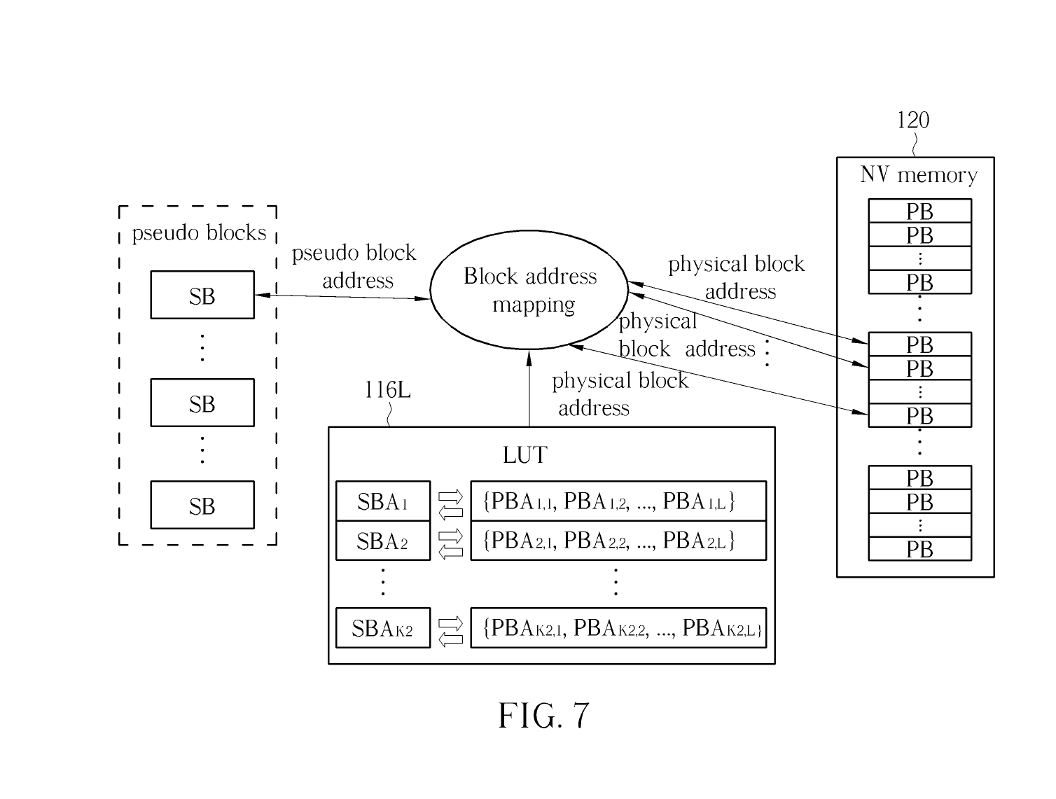

FIG. 7 is a block address mapping scheme involved with the method 200 shown in FIG. 4 according to another embodiment of the present invention. In this embodiment, some pseudo block addresses SBA₁, SBA₂, . . . , and SBA_{K2}, with the notation K2 representing a positive integer, are taken as embodiments of the pseudo block addresses respectively labeled “SBA” in FIG. 5, and some exemplary groups of physical block addresses {PBA_{1,1}, PBA_{1,2}, . . . , PBA_{1,L}}, {PBA_{2,1}, PBA_{2,2}, . . . , PBA_{2,L}}, . . . , and {PBA_{K2,1}, PBA_{K2,2}, . . . , PBA_{K2,L}}, with the notation L representing a positive integer, are taken as embodiments of the corresponding group of physical block addresses respectively labeled “{PBA}” in FIG. 5.

In the embodiment shown in FIG. 7, the LUT 116L indicates bi-directional mapping relationships between the pseudo block addresses (such as the pseudo block addresses SBA₁, SBA₂, . . . , and SBA_{K2} shown in FIG. 7) and the corresponding groups of physical block addresses (such as the groups of physical block addresses {PBA_{1,1}, PBA_{1,2}, . . . , PBA_{1,L}}, {PBA_{2,1}, PBA_{2,2}, . . . , PBA_{2,L}}, . . . , and {PBA_{K2,1}, PBA_{K2,2}, . . . , PBA_{K2,L}} shown in FIG. 7), where the contents of the LUT 116L may be updated when needed. For example, a physical blocks group, which may include L physical blocks in this embodiment, may correspond to a pseudo block. Based on the LUT 116L disclosed above, the block address mapping operation performed by the processing circuit 110 may map the pseudo block address representing the pseudo block under consideration (e.g. a pseudo block address SBAₖ₂, with the notation k2 representing an integer falling within the range of the interval [1, K2]) to the L physical block addresses respectively representing the L physical blocks corresponding to this pseudo block (e.g. a group of physical block addresses {PBA_{k2,1}, PBA_{k2,2}, . . . , PBA_{k2,L}}), or map the L physical block addresses respectively representing the L physical blocks (e.g. the group of physical block addresses {PBA_{k2,1}, PBA_{k2,2}, . . . , PBA_{k2,L}}) to the pseudo block address representing the pseudo block under consideration (e.g. the pseudo block address SBAₖ₂). Similar descriptions are not repeated in detail for this embodiment

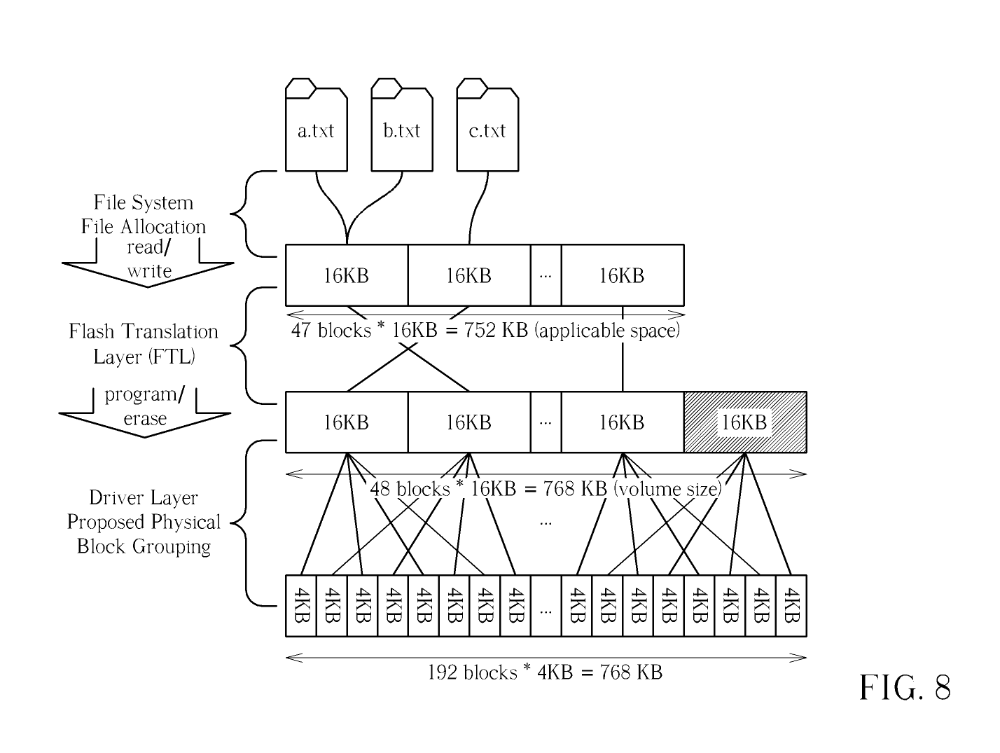

FIG. 8 is a diagram of an NV memory management system structure according to another embodiment of the present invention. In this embodiment, the proposed driver layer emulates 16 KB blocks by grouping four 4 KB blocks. Comparing to FIG. 6, the FTL can handle larger volume and less entries in translation table. Comparing to FIG. 7, the reserved space is reduced, since the block size is smaller. The proposed driver layer can emulates arbitrary sized block via block grouping. Furthermore, the emulate block size can be any multiple of physical block size, for embodiment, 12 KB, 72 KB or 240 KB. The proposed driver layer also solves the disturbance problem, through grouping the blocks that sharing common word-lines or bit-lines, i.e. emulate entire “Block Group” as a block.

It is an advantage of the present invention that the present invention method and apparatus provide block address mapping architecture/schemes, such as that of any of the embodiments/variations disclosed above, to enhance NV memory access control, and/or improve flexibility of NV memory access control. For example, in a situation where hardware resources for controlling a NOR Flash memory are limited while specifications of the NOR Flash memory indicates that the minimum size of a physical block can be either 4 kilobytes (KBs) or 64 KBs, managing the NOR Flash memory in units of a predetermined multiple of 4 KBs (e.g. 8 KBs, 12 KBs, 16 KBs, . . . , 60 KBs) according to any of the embodiments disclosed above will be helpful since both of the reserved space of the NOR Flash memory and the overall storage volume of a memory device/module implemented with the NOR Flash memory can be optimized. As a result, the related art problems will no longer be an issue.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing at least one non-volatile (NV) memory, each NV memory comprising a plurality of physical blocks, the method comprising:
managing the physical blocks of each of NV memory according to a block address mapping algorithm in a control module of a memory management apparatus, wherein the plurality of physical blocks are grouped into a plurality of physical block groups, and the block address mapping algorithm is used to mapping each of the physical block groups to a pseudo block of a plurality of pseudo blocks;
managing the plurality of pseudo blocks according to a block address translation rule in a management module of the memory management apparatus, the block address translation rule is used to mapping each of the pseudo blocks to a logical block of a plurality of logical blocks; and
when a command being detected, determining a specific pseudo block address corresponding to a specific logical block address in the command according to the block address translation rule, then determining at least one group of specific physical block addresses corresponding to the specific pseudo block address according to the block address mapping algorithm, and then processing a specific physical block group corresponding to the group of specific physical block addresses according to the command.

2. The method of claim 1, wherein the command is selected from an erase command, a read command, and a write command.

3. The method of claim 2, wherein the step of processing the specific physical block group is to erase, read or write the specific physical block group.

4. The method of claim 1, wherein the size of the logical block equals to the size of the pseudo block.

5. The method of claim 1, wherein the size of the pseudo block is a multiple of the size of the physical block.

6. The method of claim 5, wherein the size of the pseudo block is quadruple of the size of the physical block.

7. The method of claim 1, wherein the at least one NV memory comprises at least one NOR Flash memory.

8. The method of claim 7, wherein the NV memory is embedded in the portable electronic device.

9. An apparatus for managing at least one non-volatile (NV) memory, each NV memory comprising a plurality of physical blocks, the apparatus comprising:
a processing circuit comprising:
a management module for managing a plurality of pseudo blocks according to a block address translation rule, the block address translation rule being used to mapping each of the pseudo blocks to a logical block of a plurality of logical blocks; and
a control module for managing the physical blocks according to a block address mapping algorithm, wherein the plurality of physical blocks are grouped into a plurality of physical block groups, and the block address mapping algorithm is used to mapping each of the physical block groups to a pseudo block of the plurality of pseudo blocks; and for controlling access to the NV memory, wherein when a command being detected, determining a specific pseudo block address corresponding to a specific logical block address in the command according to the block address translation rule, then determining at least one group of specific physical block addresses corresponding to the specific pseudo block address according to the block address mapping algorithm, and then processing a specific physical block group corresponding to the group of specific physical block addresses according to the command.

10. The apparatus of claim 9, wherein the command is selected from an erase command, a read command, and a write command.

11. The apparatus of claim 10, wherein the control module further erasing, reading or writing the specific physical block group according to the command.

12. The apparatus of claim 9, wherein the size of the logical block equals to the size of the pseudo block.

13. The apparatus of claim 9, wherein the size of the pseudo block is a multiple of the size of the physical block.

14. The apparatus of claim 13, wherein the size of the pseudo block is quadruple of the size of the physical block.

15. The apparatus of claim 9, wherein the at least one NV memory comprises at least one NOR Flash memory.

16. The apparatus of claim 15, wherein the NV memory is embedded in the portable electronic device.
